(19) United States
(12) Patent Application Publication
(10) Pub. No.: US 2005/0033867 A1
(43) Pub. Date: Feb. 10, 2005

(54) Apparatus and method for communicating between a servo digital signal processor and a micom in an apparatus for recording and reproducing an optical disc

(76) Inventors: Dong-ki Hong, Suwon-si (KR); Jee-hyung Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/902,017

(22) Filed: Jul. 30, 2004

(30) Foreign Application Priority Data
Aug. 8, 2003 (KR) 2003-55026
Feb. 21, 2004 (KR) 2004-11669

(51) Int. Cl. G06F 3/00

(52) U.S. Cl. 710/1

(57) ABSTRACT

An apparatus and method for communicating between a servo digital signal processor (DSP) and a micom in an optical recording and reproducing apparatus comprises transmitting an operation command to the servo DSP through a predetermined first port via the micom, transmitting a command completion signal to the micom through a predetermined second port via the servo DSP, transmitting a request for a result code of performing the command to the servo DSP through the first port via the micom, generating and transmitting the result code of performing the command to the micom through the first code via the servo DSP, and transmitting a subsequent operation command to the servo DSP through the first port, or retransmitting the current operation command via the micom upon receiving the result code for performing the command.

### CROSS-REFERENCE TO RELATED APPLICATIONS

This application claims the benefit under 35 U.S.C. § 119(a) of Korean Application No. 2003-55026, filed Aug. 8, 2003, and No. 2004-11669, filed Feb. 21, 2004 in the Korean Intellectual Property Office, the entire content of which is incorporated herein by reference.

### BACKGROUND OF THE INVENTION

1. Field of the Invention

The present invention relates to an apparatus and method for communicating between a servo digital signal processor (DSP) and a micom in an apparatus for recording and reproducing an optical disc. More particularly, the present invention relates to an apparatus and method for communicating between a servo digital signal processor (DSP) and a micom in an apparatus for recording and reproducing onto optical disc, which provides improved functions of the micom in terms of determining its status regarding a normal mode or an emergency mode.

2. Description of the Related Art

FIG. 1 is a block diagram illustrating an apparatus for communicating between a micom 101 and a servo digital signal processor (DSP) 100 in a conventional optical recording and producing apparatus. The optical recording and reproducing apparatus comprises a servo DSP chip 100 for reading a signal from an optical disc (not shown), driving a pickup to write a signal on the optical disc, and processing the signal read by the pickup into a digital signal. The micom 101 controls the servo DSP chip 100, and the servo DSP chip 100 outputs a processed signal received from the micom 101 using a sense port.

The servo DSP chip 100 and the micom 101 communicate in normal operation and in an emergency mode respectively as described below.

When an external micom 101 commands control of the servo DSP chip 100, the sense port is switched from a high mode to a low mode, and the micom 101 waits for a subsequent command until the sense port is switched to a high mode. The servo DSP chip 100, which received the command, operates as commanded, and returns the sense port to a high mode after completing the operation. The micom 101 may check a state of the sense port prior to performing the subsequent command. Alternatively, the micom 101 may check a state of the external ports 102 which are externally connected, to determine whether the micom 101 and the servo DSP chip 100 are operating normally as commanded, thereby confirming completion of the command prior to performing the subsequent command.

The communication method between the servo DSP chip 100 and the micom 101 in an emergency mode will now be described.

When an emergency occurs due to an external impact, vibration or other situation, the micom 101, which continuously monitors signals of the external ports 102, perceives and responds to the emergency. For example, the micom 101 may continuously check the state of the sense port when no specific command is received, or monitor the signals indicating current states of tracking or focusing via the external ports 102 in order to detect an emergency.

The above-described communication method between the servo DSP chip 100 and the micom 101 in an optical recording and reproducing apparatus is disclosed in U.S. Pat. No. 5,614,792, the entire contents of which is incorporated herein by reference.

In the conventional optical recording and reproducing apparatus, the micom 101 could not directly detect from the servo DSP whether the servo DSP chip 100 completed the operation, but just monitors the externally connected additional ports 102 in order to monitor the operational state of the DSP chip 100. Accordingly, external ports 102 are inevitably added, and the reliability of the micom 101 in checking the operational state deteriorates.

Furthermore, since the micom 101 should always monitor the external ports 102 in anticipation of an emergency, the micom 101 requires most of the computer code and requires a large amount of time for servo-related operations. Therefore, the function of the system deteriorates. Additionally, according to the number of the external ports 102, the efficiency of detecting the emergency is limited.

### SUMMARY OF THE INVENTION

An aspect of the present invention is to solve at least the above problems and provide at least the advantages described below. Accordingly, an aspect of the present invention is to provide a communication apparatus and method between a servo Digital Signal Processing (DSP) chip and a micom in an optical recording and reproducing apparatus in which the micom is capable of directly checking the status of the DSP chip without using external ports. The servo DSP chip is capable of determining whether it has completely performed a command, thereby enhancing a reliability of the operation.

Another aspect of the present invention is to provide a communication apparatus and method between a servo DSP chip and a micom in an optical recording and reproducing apparatus in which the micom is better able to handle an emergency so that space required for the micom in a CPU program is reduced, thereby improving a function of the whole system.

In order to achieve the above-described aspects of the present invention, there is provided an apparatus and method for communicating between a servo DSP which drives a pickup to read and write a signal from an optical disc, and a micom which controls the servo DSP. The communication apparatus and method comprise the transmitting an operation command to the servo DSP through a predetermined first port via the micom; transmitting a command completion signal to the micom through a predetermined second port via the servo DSP; transmitting a request for a result code for performing the command to the servo DSP through the first port via the micom; transmitting the result code for performing the command to the micom through the first code via the servo DSP; and transmitting a subsequent operation command to the servo DSP through the first port, or retransmitting the current operation command upon receiving the result code of performing the command via the micom.

The step of transmitting the result code may further comprise transmitting the command completion signal to the micom through the second port.

If the result code received in the step of transmitting the subsequent operation command is normal, transmitting the subsequent operation command to the servo DSP through the first port.

If the result code received in the step of transmitting the subsequent operation command is abnormal, the micom retransmits the current operation command to the servo DSP, and repeating the steps of transmitting the command completion signal through the steps of transmitting the result code.

If the micom receives the abnormal result code even after a predetermined amount of retransmissions, the micom transmits a subsequent command corresponding to the error of the servo DSP through the first port.

In order to achieve the above aspect of the present invention, there is provided an apparatus and method for communicating between a servo DSP for driving a pickup to read and write a signal from an optical disc and processing the signal read by the pickup to a digital signal, and a micom for controlling the servo DSP. The communication apparatus and method comprise transmitting an emergency generation signal to the micom through a predetermined first port when an emergency occurs due to an external impact or other defects via the servo DSP; transmitting a request for an error code in an emergency routine to the servo DSP through the first port via the micom; transmitting the error code to the micom through the first port via the servo DSP; and transmitting a command for solving the emergency to the servo DSP through the first port via the micom upon receiving the error code.

The step of transmitting the request for an error code further comprises transmitting a command completion signal to the micom through a predetermined second port via the servo DSP.

In order to achieve the above aspect of the present invention, there is provided an apparatus and method for communicating between a servo DSP for driving a pickup to read and write a signal from an optical disc and processing the signal read by the pickup into a digital signal, and a micom for controlling the servo DSP. The communication apparatus and method comprise when transmitting an interrupt generation signal to the micom via the servo DSP when an error occurs during the servo operation; transmitting a request for an error code in an interrupt routine to the servo DSP via the micom; transmitting an error code representing an error state and a state of the servo operation prior to the error to the micom in response to the request for an error code; generating and transmitting a subsequent operation command for solving the error to the servo DSP based on the error code received from the servo DSP; and solving the error by performing the subsequent operation command, and returning to the servo operation state prior to the error upon receiving the subsequent operation command via the servo DSP.

The error state comprises one of a focus drop, a tracking-off, and a constant linear velocity (CLV) unlock.

The subsequent operation command comprises a command for returning to the servo operation state prior to the error.

In order to achieve the above aspect of the present invention, there is provided a communication apparatus and method between a servo DSP for driving a pickup to read and write a signal from an optical disc and processing the signal read by the pickup to a digital signal, and a micom for controlling the servo DSP. The apparatus and method comprise transmitting an interrupt generation signal to the micom when an error occurs during the servo operation via the servo DS; transmitting a request for an error code in an interrupt routine to the servo DSP via the micom; transmitting an error code representing an error state to the micom in response to the request; generating and transmitting a subsequent operation command for solving the error to the servo DSP based on the error code received from the servo DSP; and solving the error by performing the subsequent operation command, and returning to the servo operation state prior to the error using a servo operation state information stored in a certain internal register upon receiving the subsequent operation command via the servo DSP.

### BRIEF DESCRIPTION OF THE DRAWING FIGURES

The above aspect and other features of the present invention will become more apparent by describing in detail exemplary embodiments thereof with reference to the accompanying drawing figures, wherein;

FIG. 1 is a block diagram illustrating an apparatus for communicating between a servo Digital Signal Processor (DSP) and a micom in a conventional optical recording and reproducing apparatus;

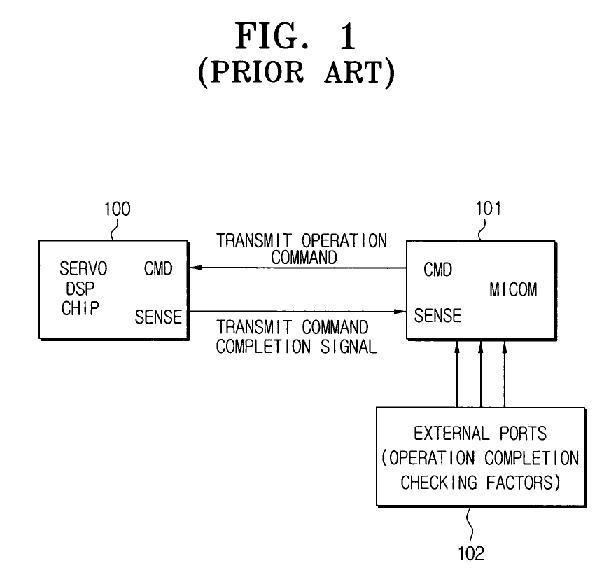

FIG. 2 is a diagram illustrating a communication method between a servo DSP and a micom in an optical recording and reproducing apparatus according to an embodiment of the present invention;

FIG. 3 is a diagram illustrating a communication method between a servo DSP and a micom in an optical recording and reproducing apparatus according to another embodiment of the present invention;

FIG. 4 is a diagram illustrating a communication method between a servo DSP and a micom in an optical recording and reproducing apparatus according to another embodiment of the present invention; and

FIG. 5 is a diagram illustrating a communication method between a servo DSP and a micom in an optical recording and reproducing apparatus according to yet another embodiment of the present invention.

Throughout the drawings, it should be noted that the same or similar elements are denoted by like reference numerals.

### DETAILED DESCRIPTION OF THE EXEMPLARY EMBODIMENTS

Hereinafter, embodiments of the present invention will be described in detail with reference to the accompanying drawing figures.

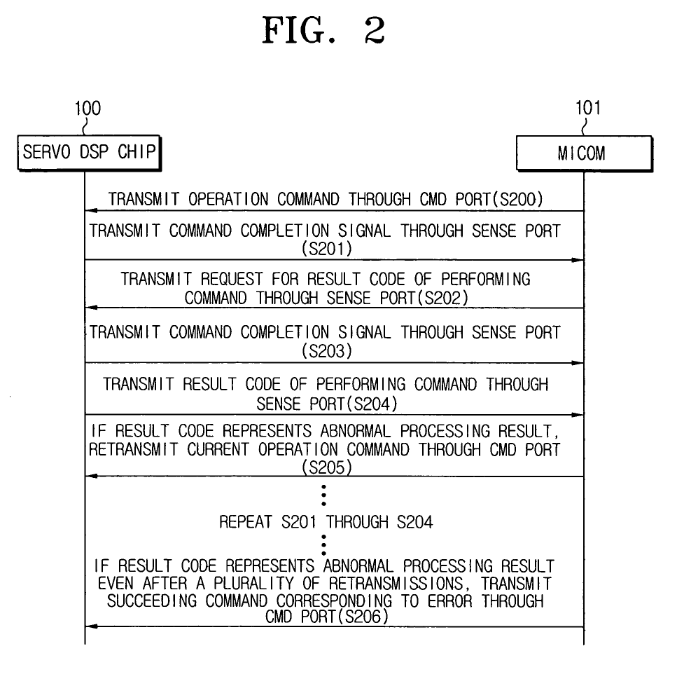

Referring to FIG. 2, a communication method between a servo digital signal processor (DSP) and a micom, according to an embodiment of the present invention is shown. An operation command is transmitted through a command (CMD) port for communicating between a servo DSP chip 100 and a micom 101 in a normal mode at step S200. The command completion signal is transmitted through a sense port at step S201. A request for a result code for performing the command is transmitted through the CMD port at step S202. The command completion signal is transmitted through the sense port at step S203. The result code for performing the command is transmitted through the CMD port at step S204. The operation command is retransmitted through the CMD port when the result code for performing the command represents an abnormal processing result at step S205., If the result code for performing the command still represents the abnormal processing result even after a plurality of the retransmissions, a subsequent command corresponding to the error occurred is transmitted through the CMD port at step S206.

The communication method between the servo DSP chip 100 and the micom 101 in the normal mode will now be described in greater detail below.

The optical recording and reproducing apparatus comprises the servo DSP chip 100 for driving a pickup to read a signal from an optical disc (not shown) or to write a signal on the optical disc, and processing the signal read by the pickup into a digital signal. A micom 101 controls the servo DSP chip 100, and transmits a command for operating the servo DSP chip 100 through the CMD port. The servo DSP chip 100 transmits a result of performing the operation command transmitted from the micom 101 using the sense port.

The micom 101 transmits through the CMD port an operation command for operating the servo DSP chip 100 (S200).

The servo DSP chip 100 commanded by the micom 101 performs the operation command and transmits the operation command completion signal through the sense port at step S201. The servo DSP chip 100, which received the operation command, switches the sense port from a high mode to a low mode, and returns the sense port to a high mode after completing the operation. After transmitting the operation command to the servo DSP chip 100, the micom 101 waits until the sense port is switched to a high mode.

When the micom 101 confirms the high mode of the sense port, the micom 101 transmits a request for a result code of performing the command to the servo DSP chip 100 through the CMD port at step S202.

The servo DSP chip 100, which received the request from the micom 101, performs the operation command, and transmits the command completion signal to the micom 101 through the sense port at step S203. The servo DSP chip 100, which received the request, switches the sense port from the high mode to the low mode, detects the result code of performing the command stored in a certain internal register, and if the command is completely performed, returns the sense port to the high mode. After transmitting the operation command to the servo DSP chip 100, the micom 101 waits until the sense port is switched to a high mode.

The servo DSP chip 100 transmits the result code of performing the command to the micom 101 through the sense port. The micom 101, which received the result code of performing the command, determines whether the result code shows a normal processing result or an abnormal processing result. When the result code is normal, the micom 101 transmits a subsequent operation command to the servo DSP chip 100 through the CMD port.

When the result code represents an abnormal processing result, the micom 101 retransmits the current operation command to the servo DSP chip 100 through the CMD port at step S205. Then, steps S201 through S204 are repeated.

If the result code of performing the command still represents an abnormal processing result even after the retransmission, the micom 101 transmits a subsequent command corresponding to the error that occurred to the servo DSP chip 100 through the CMD port at step S206.

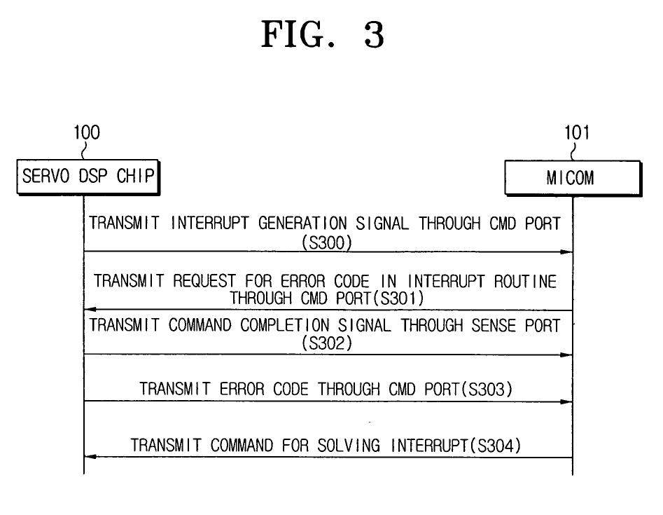

FIG. 3 is a diagram illustrating a communication method between a servo DSP and a micom in an optical recording and reproducing apparatus according to another embodiment of the present invention. Referring to FIG. 3, the communication method comprises the steps of transmitting an interrupt generation signal through the CMD port in an emergency situation for communicating between the servo DSP chip 100 and the micom 101 at step S300. A request for an error code in an interrupt routine is transmitted through the CMD port at step S301. A command completion signal is transmitted through the sense port at step S302 The error code is transmitted through the CMD port at step S303, and a command is transmitted for solving the interrupt at step S304.

The communication method between the servo DSP chip 100 and the micom 101 in the emergency mode will be described in greater detail. The emergency refers to when the error or the interrupt is generated.

The optical recording and reproducing apparatus comprises the servo DSP chip 100 for driving a pickup to read a signal from an optical disc (not shown) or to write a signal on the optical disc, and processing the signal read by the pickup into a digital signal. A micom 101 controls the servo DSP chip 100, and transmits a command for operating the servo DSP chip 100 to the servo DSP chip 100 through the CMD port. The servo DSP chip 100 outputs to the micom 101 a result of performing the command transmitted from the micom 101 using the sense port.

When the servo DSP chip 100 has an interrupt due to an external impact or other defects, the servo DSP chip 100 transmits an interrupt generation signal to the micom 101 through the CMD port at step S300.

On detection of the interrupt of the servo DSP chip 100, the micom 101 transmits a request for the error code in the interrupt routine to the servo DSP chip 100 through the CMD port at step S301.

The servo DSP chip 100, which received the request for the error code from the micom 101, performs the operation command, and transmits the command completion signal to the micom 101 through the sense port at step S302. The servo DSP chip 100, which received the request for the error code from the micom 01, switches the sense port from the high mode to the low mode, and returns the sense port to the high mode after completing the operation. After transmitting the operation command to the servo DSP chip 100, the micom 101 waits until the sense port is switched to a high mode.

The servo DSP chip 100 transmits the error code, generated in the interrupt routine to the micom 101 through the CMD port at step S303.

The micom 101, which received the error code from the servo DSP chip 100, detects a current interrupt, moves to a module for solving the interrupt, and transmits a command for solving the interrupt at step S304.

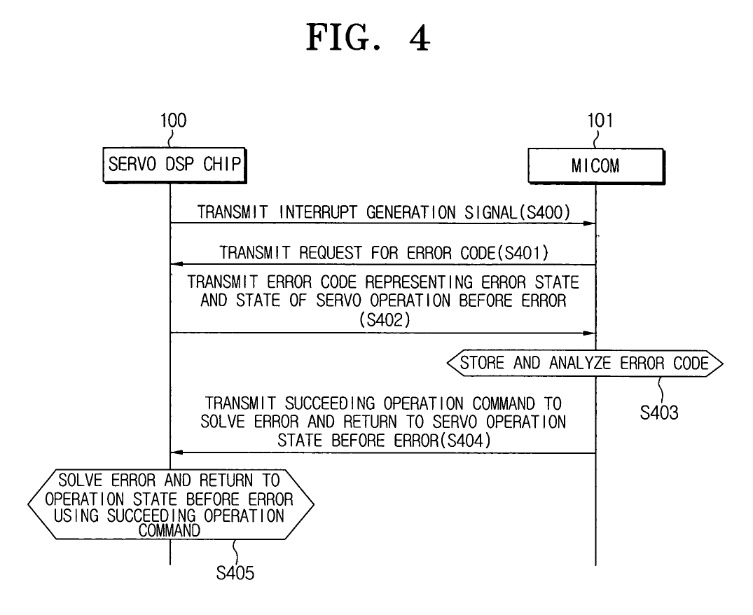

FIG. 4 is a diagram for illustrating a communication method between a servo DSP and a micom in an optical recording and reproducing apparatus according to another embodiment of the present invention. In essence, FIG. 4 illustrates the communication method between the servo DSP chip 100 and the micom 101 in an emergency.

The optical recording and reproducing apparatus comprises the servo DSP chip 100 for driving a pickup to read a signal from an optical disc (not shown) or to write a signal on the optical disc, and processing the signal read by the pickup to a digital signal. The micom 101 controls the servo DSP chip 100, and transmits a command for operating the servo DSP chip 100 through the CMD port. Additionally, the micom 101 comprises an error processing module (not shown) to solve the error generated in the servo DSP chip 100. For the error processing module, a focus drop processing module, a tracking-off processing module and a constant linear velocity (CLV) unlock processing module, can be applied. The servo DSP chip 100 transmits a result of performing the command transmitted from the micom 101 through the sense port.

Referring to FIG. 4, during the servo operation for reproducing the signal recorded in the optical disc or recording a predetermined signal on the optical disc, if an error occurs in the optical recording and reproducing apparatus due to an external impact or disc defect, the servo DSP chip 100 transmits an interrupt generation signal to the micom 101 through the CMD port to indicate the occurrence of the error at step S400. The servo DSP chip 100 also stores an error code to a certain register. The error code represents the error state and a state of the servo operation before the occurrence of the error. Exemplary errors which occur during the servo operation are a focus drop, a tracking-off, and a CLV unlock.

On detection of the interrupt of the servo DSP chip 100, the micom 101 transmits a signal for requesting the error code, which is produced in response to the error in the interrupt routine, to the servo DSP chip 100 through the CMD port at step S401.

Receiving the signal for requesting the error code from the micom 101, the servo DSP chip 100 transmits the error code stored in a certain register, which represents the error state and the state of the servo operation prior to the error, to the micom 101 through the CMD port at step S402.

When the error code is received from the servo DSP chip 100, the micom 101 stores and analyzes the error code to detect the current state of the error and the state of the servo operation prior to the error at step S403. For this, the micom 101 moves to a module for solving the error, and generates a subsequent operation command corresponding to the error. In addition, the micom 101 transmits the subsequent operation command to the servo DSP chip 100 through the CMD port at step S404. The subsequent operation command corresponding to the error includes a command for solving the error, and a command for returning to the servo operation prior to the occurrence of the error.

For example, when the current error is the focus drop as a result of the error code analysis, the micom 101 moves to the focus drop processing module. The micom 101 checks the state of the servo operation before the focus drop, and generates a subsequent operation command to be transmitted to the servo DSP chip 100. If the focus drop is generated with only the focus servo in the on state, the micom 101 transmits only a focus-on command to the servo DSP chip 100. If the focus drop is generated with both the focus servo and the tracking servo in the on state, the micom 101 transmits the focus-on command and a tracking-on command to the servo DSP chip 100. If the focus drop is additionally generated with the CLV locked in the above state, the micom 101 sequentially transmits the focus-on command, the tracking-on command, and a CLV-on command to the servo DSP chip 100.

When the current error is the tracking-off as a result of the analysis, the micom 101 moves to the tracking-off processing module to generate an operation command to be transmitted to the servo DSP chip 100. For instance, if the tracking-off is generated with the tracking servo on, the micom 101 transmits the focus-on command and the tracking-on command to the servo DSP chip 100. If the tracking-off is generated with the CLV locked, the micom 101 transmits all of the focus-on command, the tracking-on command, and the CLV-on command to the servo DSP chip 100.

When the current error is the CLV unlock as a result of the analysis, the micom 101 moves to the CLV unlock processing module, and generates an operation command to be transmitted to the servo DSP chip 100. In case of a CLV unlock error, the micom 101 sequentially transmits the focus-on command, the tracking-on command, and the CLV-on command to the servo DSP chip 100 through the CMD port.

On receiving the subsequent operation command corresponding to the error from the micom 101, the servo DSP chip 100 performs as commanded to solve the error, and returns to a state of the servo operation before the occurrence of the error at step S405.

Although examples where the subsequent operation command is transmitted from the micom 101 to return to the servo operation state before the error occurrence have been described above, the embodiments of the present invention are not limited to those described. For example, only the command for solving the error may be transmitted from the micom 101, and the servo DSP chip 100 may return to the servo operation state prior to the error occurring, using a servo operation state information stored in the certain internal register.

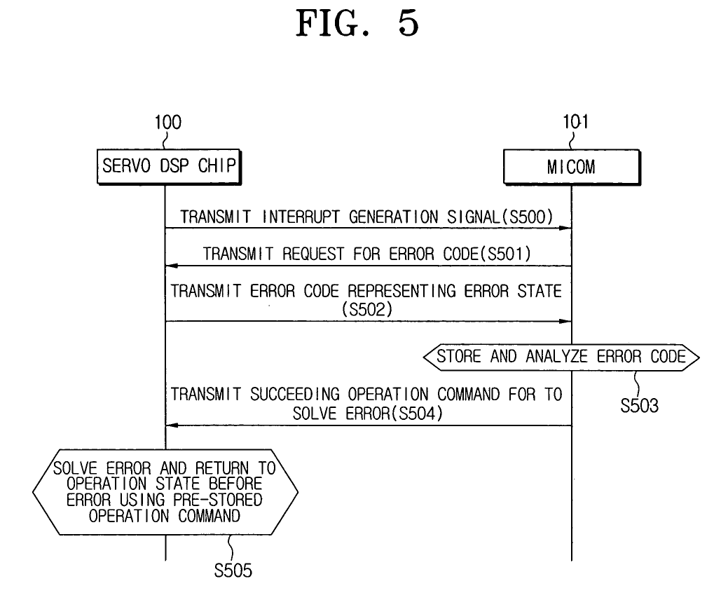

FIG. 5 is a diagram illustrating the communication method between a servo DSP and a micom in an optical recording and reproducing apparatus according to yet another embodiment of the present invention. In essence, FIG. 5 illustrates the communication method between the servo DSP chip 100 and the micom 101 in an emergency.

Referring to FIG. 5, if an error occurs during the servo operation such as an automatic servo adjustment, an optical power adjustment, and recording and reproducing operation, the servo DSP chip 100 transmits an interrupt generation signal to the micom 101 at step S500. The micom 101, which received the interrupt generation signal from the servo DSP chip 100, transmits a signal to the servo DSP chip 100, through the CMD port, requesting the error code.

In response to the request signal, the servo DSP chip 100 transmits the error code representing the error state to the micom 101 through the CMD port at step S502. The micom 101, which received the error code from the servo DSP chip 100, stores and analyzes the received error code to detect the current error state and the state of the servo operation prior to the occurrence of the error at step S503. For this, the micom 101 moves to the error processing module corresponding to the error, and generates a subsequent operation command to solve the error. The micom 101 transmits the generated subsequent operation command to the servo DSP chip 100 through the CMD port at step S504.

On receiving the subsequent operation command corresponding to the error from the micom 101, the servo DSP chip 100 performs the subsequent operation command to solve the error, and returns to the servo operation state prior to the error occurrence, using a servo operation state information stored in the certain internal register at step S505.

As can be appreciated from the description of the fourth embodiment, unlike the third embodiment, only the error code representing the error state is transmitted in response to the signal of the micom 101 requesting the error code. Another difference is that the micom 101 only transmits the subsequent operation command for solving the error to the servo DSP chip 100, and the servo DSP chip 100 returns to the servo operation state prior to the error occurrence, using the servo operation state information stored to the certain internal register.

According to the described embodiments, the present invention can provide merits as follows.

First, the micom 101 can directly check the reliability in the operation of the optical recording and reproducing apparatus.

In the conventional method, after commanding to the servo DSP chip 100, the micom 101 can check a result of processing the command, through the servo DSP which is the subject of the operation, or by monitoring the peripheral ports which are externally connected. However, according to the embodiments of the present invention, the micom 101 can check for the completion of the command directly from the servo DSP, thereby improving the operation reliability.

Second, the number of the external ports can be reduced.

Since the micom 01 directly receives the command completion code or the error code from the servo DSP, the external ports used in the conventional method are not required as much. Therefore, the number of the ports is reduced.

Third, the micom 101 does not require a majority of the coding for the program, thereby improving the whole function of the system.

In the conventional method, the micom 101 has to monitor the external ports 102 to determine the occurrence of an emergency via the external ports all the time, and therefore, occupancy of the micom 101 in a program is increased, deteriorating the whole function of the system. However, according to an embodiment of the present invention, since the servo DSP indicates an emergency by generating the interrupt, the micom 01 does not have to monitor for the emergency. Accordingly, the micom 101 can perform other tasks instead, thereby improving the whole function of the system.

Fourth, the servo DSP chip 100 is able to properly cope with an emergency.

The servo DSP chip 100 can solve the error, and also automatically returns to the servo operation state prior to the error occurrence, by storing the servo operation state information in case of the emergency.

Fifth, an algorithm for solving an emergency can be modulated.

The diversity of servo errors incurred in the optical recording and reproducing apparatus are integrally managed by a regulated error processing module, and therefore, the error code can be efficiently implemented. When a new error is found, an error processing module corresponding to the new error is simply added.

While the invention has been shown and described with reference to certain embodiments thereof, it should be understood by those skilled in the art that various changes in form and details may be made therein without departing from the spirit and scope of the invention as defined by the appended claims.

1. A method for communicating between a servo DSP and a micom, the servo DSP for driving a pickup to read and write a signal relative to an optical disc and processing the signal read by the pickup into a digital signal, and the micom for controlling the servo DSP, the communication method comprising the steps of:
transmitting an operation command to the servo DSP through a first port via the micom;
transmitting a command completion signal to the micom through a second port via the servo DSP;
transmitting a request for a result code of performing the command to the servo DSP through the first port via the micom;
transmitting the result code of performing the command to the micom through the first port via the servo DSP; and
transmitting a subsequent operation command to the servo DSP through the first port, or retransmitting the current operation command via the micom upon receiving the result code of performing the command.

2. The communication method of claim 1, wherein the step of transmitting the request for result code further comprises:
transmitting the command completion signal to the micom through the second port.

3. The communication method of claim 1, further comprises:
transmitting the subsequent operation command to the servo DSP through the first port if the result code received in the fifth step represents a normal processing result.

4. The communication method of claim 1, further comprises:
retransmitting the current operation command to the servo DSP, and repeating the steps of transmitting the command completion signal through the steps of transmitting the result code via the micom if the result code received in the fifth step represents a normal processing result.

5. The communication method of claim 4, wherein, if the micom receives the abnormal result code even after a plurality of retransmissions, the micom transmits a subsequent command corresponding to an error to the servo DSP through the first port.

6. A method for communicating between a servo DSP and a micom, the servo DSP for driving a pickup to read and write a signal relative to an optical disc and processing the signal read by the pickup into a digital signal, and the micom for controlling the servo DSP, the communication method comprising the steps of:
transmitting an emergency generation signal to the micom through a predetermined first port when an emergency occurs due to an external impact or other defects via the servo DSP;
transmitting a request for an error code in an emergency routine to the servo DSP through the first port via the micom;
transmitting the error code to the micom through the first port via the servo DSP; and
transmitting a command for solving the emergency to the servo DSP through the first port via the micom upon receiving the error code.

7. The communication method of claim 6, wherein the step of transmitting the request for the error code further comprises:
transmitting a command completion signal to the micom through a predetermined second port via the servo DSP.

8. A method for communicating between a servo DSP and a micom, the servo DSP for driving a pickup to read and write a signal relative to an optical disc and processing the signal read by the pickup into a digital signal, and the micom for controlling the servo DSP, the communication method comprising the steps of:
transmitting an interrupt generation signal to the micom via the servo DSP when an error occurs during the servo operation;
transmitting a request for an error code in an interrupt routine to the servo DSP via the micom;
transmitting an error code representing an error state and a state of the servo operation prior to the occurrence of the error to the micom in response to the request;
(generating and transmitting a subsequent operation command for solving the error to the servo DSP based on the error code received from the servo DSP; and
solving the error by performing the subsequent operation command, and returning to the servo operation state before the error via the servo DSP upon receiving the subsequent operation command.

9. The communication method of claim 8, wherein the error state comprises one of a focus drop, a tracking-off, and a constant linear velocity (CLV) unlock.

10. The communication method of claim 8, wherein the subsequent operation command comprises an operation command for returning to the servo operation state prior to the error.

11. A method for communicating between a servo DSP and a micom, the servo DSP for driving a pickup to read and write a signal relative to an optical disc and processing the signal read by the pickup into a digital signal, and the micom for controlling the servo DSP, the communication method comprising the steps of:
transmitting an interrupt generation signal to the micom via the servo DSP when an error occurs during the servo operation;
transmitting a request for an error code in an interrupt routine to the servo DSP via the micom;
transmitting an error code representing an error state to the micom in response to the request via the servo DSP;
generating and transmitting a subsequent operation command for solving the error to the servo DSP based on the error code received from the servo DSP; and
solving the error by performing the subsequent operation command, and returning to the servo operation state information stored in a certain internal register prior to the errors occurring by using a servo operation state.

12. The communication method of claim 11, wherein the error state comprises one of a focus drop, a tracking-off, and a constant linear velocity (CLV) unlock.

13. An apparatus adapted to provide communication between a servo DSP and a micom, the apparatus comprises:
the servo DSP adapted to drive a pickup to read and write a signal relative to an optical disc, process the signal read by the pickup into a digital signal, transmit a command completion signal to the micom through a second port, and
the micom adapted to control the servo DSP, transmit an operation command to the servo DSP through a first port, transmit a request for a result code of performing the command to the servo DSP through the first port, transmit the result code of performing the command to the micom through the first port via the servo DSP, and transmit a subsequent operation command to the servo DSP through the first port or retransmit the current operation command upon receiving the result code of performing the command.

14. The apparatus of claim 13, wherein the servo DSP is further adapted to transmit the command completion signal to the micom through the second port.

15. The apparatus of claim 13, wherein the micom is further adapted to transmit the subsequent operation command to the servo DSP through the first port if the result code received represents a normal processing result.

16. The apparatus of claim 13, wherein the micom is further adapted to retransmit the current operation command to the servo DSP, and repeat the transmitting of the command completion, the request for the result code, and the subsequent operation command if the result code received when the subsequent operation command represents a normal processing result.

17. The apparatus of claim 16, wherein, if the micom receives the abnormal result code even after a plurality of retransmissions, the micom transmits a subsequent command corresponding to an error to the servo DSP through the first port.
